(19) United States
(12) Patent Application Publication
(10) Pub. No.: US 2022/0205065 A1
(43) Pub. Date: Jun. 30, 2022

(54) METHOD FOR SEPARATING YTTRIUM OXIDE FROM HIGH-YTTRIUM RARE EARTH ORE BY GROUPING MANNER AND METHOD FOR SEPARATING YTTRIUM OXIDE FROM MEDIUM-YTTRIUM AND EUROPIUM-RICH EARTH ORE BY GROUPING MANNER

(71) Applicant: CHANGCHUN INSTITUTE OF APPLIED CHEMISTRY CHINESE ACADEMY OF SCIENCES, Changchun City, Jilin (CN)

(72) Inventors: Ji CHEN, Changchun City (CN); Yuefeng DENG, Changchun City (CN); Deqian LI, Changchun City (CN); Hailian LI, Changchun City (CN); Maohua YANG, Changchun City (CN); Yu LIU, Changchun City (CN); Dan ZOU, Changchun City (CN); Yan BAI, Changchun City (CN); Yongqing CHANG, Changchun City (CN)

(21) Appl. No.: 17/601,887

(22) PCT Filed: Oct. 10, 2019
(86) PCT No.: PCT/CN2019/110337

§ 371 Date: Oct. 6, 2021

(30) Foreign Application Priority Data
Apr. 17, 2019 (CN) 201910307023.X
Apr. 17, 2019 (CN) 201910307028.2

(51) Int. Cl. C22B 59/00; C22B 3/40; C01F 17/218; C01F 17/229

(52) U.S. Cl. CPC C22B 59/00; C01F 17/229; C01F 17/218; C22B 3/402

(57) ABSTRACT

The present disclosure relates to a method for separating yttrium oxide from a high-yttrium rare earth ore by a grouping manner and a method for separating yttrium oxide from a medium-yttrium and europium-rich rare earth ore by a grouping manner, and belongs to the technical field of rare earth extraction and separation. The separating method by a grouping manner according to the present disclosure have advantages such as being advanced and reasonable, short process, low production cost, good adaptability, and easy operation and control. The method has better overall technical and economic indicator performance than the naphthenic acid process and has the value of practical application.

### CROSS-REFERENCE TO RELATED APPLICATION

This application claims the benefit of priority to Chinese Application No. 201910307023.X filed on Apr. 17, 2019 and Chinese Application No. 201910307028.2 filed on Apr. 17, 2019, the disclosure of which is incorporated herein by reference in its entirety.

### FIELD OF THE INVENTION

The present disclosure belongs to the technical field of rare earth extraction and separation, and particularly relates to a method for separating yttrium oxide from a high-yttrium rare earth ore by a grouping manner and a method for separating yttrium oxide from a medium-yttrium and europium-rich rare earth ore by a grouping manner.

### BACKGROUND OF THE INVENTION

In southern China, ion-adsorption rare earth ores have a complete element pattern, and mainly contains middle and heavy rare earths, rich in middle and heavy rare earths such as europium, terbium, dysprosium, erbium, lutetium, and yttrium required for functional materials. The ion-adsorption rare earth ores are unique strategic resources in China. Ion-adsorption ores are mainly distributed in southern provinces in China, such as Jiangxi, Fujian, Guangdong, Hunan and Guangxi or the like. According to the element pattern characteristics, the rare earth ores can be classified into a light rare earth type, a medium-yttrium and europium-rich type and a high-yttrium type (also known as a heavy rare earth type). The high-yttrium rare earth ore has a middle and heavy rare earth content of about 90%, wherein the contents of lutetium oxide and yttrium oxide are around 0.47% and 65% respectively. The element pattern of the medium-yttrium and europium-rich rare earth ore is characterized by: (1) an europium content of 0.5%-1.0%; (2) a light rare earth content and a middle and heavy rare earth content each of about 50%; (3) a middle rare earth (samarium, europium, terbium, dysprosium) content of about 10%; and (4) a yttrium oxide content of 20%-30%. The high-yttrium ionic ore and the medium-yttrium and europium-rich ionic ore have high content of middle and heavy rare earths, and are very valuable to be separated, so they have become important minerals used in China's rare earth industry. The preferential separation of higher content of yttrium oxide is one of the key steps for the separation process for the high-yttrium rare earth ore and the medium-yttrium and europium-rich rare earth ore. Currently, the separation of yttrium oxide from the high-yttrium rare earth ore or the medium-yttrium and europium-rich rare earth ore mainly uses a naphthenic acid system to directly separate yttrium oxide. The naphthenic acid extraction separation of yttrium oxide has been widely used in the separation process for the heavy rare earth. However, the industrial practice indicates that the process suffers from some problems: because the naphthenic acid is a byproduct of petroleum processing, it has a complex composition and relatively large water solubility, and will change in composition after long term use, influencing the stability of the process; emulsification easily occurs when extracting rare earth at higher pH; and the separation factor between lanthanum and yttrium is small due to the composition of the raw material, the temperature and so on, which makes the separation of yttrium and lanthanum very difficult. In recent year, with the development of further processing technology of petrochemical products, the production of the naphthenic acid byproduct of petroleum cracking which is suitable for separating yttrium oxide has been substantially stopped. Therefore, there is an urgent need to develop a process for separating yttrium oxide to replace the existing naphthenic acid separation process.

For example, Chinese Patent No. ZL 99118261.8 proposes an HAB double solvent extraction system based on a carboxylic acid-type extractant HA, in which CA12 (sec-octylphenoxy acetic acid) or the like is used as a main extractant (HA), to improve the extraction efficiency of light rare earth and yttrium. An acidic organophosphourus extractant or a monosulfur-substituted derivative thereof, such as P507 (2-ethylhexyl phosphonic acid mono-2-ethylhexyl ester) and Cyanex272 (bis(2,4,4-trimethylpentyl) phosphonic acid) is used as a co-extractant (HB) to improve the extraction efficiency of heavy rare earth and yttrium. The HAB system maintains the advantage of higher separation factor of La/Y in the HA system than in naphthenic acid, and overcomes the shortcoming of low separation factor between Tm, Yb, Lu and Y in the HA system. The HAB process is superior to the naphthenic acid extraction process under the same conditions. However, the HAB system suffers from the problem in long term use that the changes in concentrations of two extractants are difficult to be rapidly analyzed on site, which limits its industrial application.

### SUMMARY OF THE INVENTION

The present disclosure is to solve the above technical problems in existing processes for separating yttrium with a naphthenic acid system and an HAB mixed system. The present disclosure provides a method for separating yttrium oxide from a high-yttrium rare earth ore by a grouping manner and a method for separating yttrium oxide from a medium-yttrium and europium-rich rare earth ore by a grouping manner. In the method for separating yttrium oxide from a high-yttrium rare earth ore by a grouping manner, the high-yttrium rare earth ore is firstly separated with a P507-isooctanol mixed system or the like by an erbium-thulium grouping manner to obtain a high-yttrium enriched material and a thulium-ytterbium-lutetium-enriched material, the thulium-ytterbium-lutetium-enriched material is further separated to prepare heavy rare earths such as lutetium oxide or the like, then the high-yttrium enriched material is separated with a mixed system of a carboxylic acid-based extractant HA-TBP (tri-n-butyl phosphate) to prepare yttrium oxide, and finally the La—Er enriched material is separated into other individual rare earths with a P507 system by a grouping manner. In another aspect, in the method for separating yttrium oxide from a medium-yttrium and europium-rich rare earth ore by a grouping manner, the medium-yttrium and europium-rich rare earth ore is firstly separated with a mixed system of P507-isooctanol or the like by a dysprosium-holmium grouping manner to obtain a yttrium-rich material 1 (Ho—Lu Y) and a light and middle rare earth-enriched material (La—Dy), the light and middle rare earth-enriched material is further separated into individual rare earths with a P507 system; then the yttrium-rich material 1 is separated with a mixed system of P507-isooctanol or the like by an erbium-thulium grouping manner to obtain a yttrium-rich material 2 (Ho Er Y) and a thulium-ytterbium-lutetium-enriched material, the thulium-ytterbium-lutetium-enriched material is further separated into individual heavy rare earths; and finally the yttrium-rich material 2 is separated with an HA-TBP mixed system to prepare yttrium oxide. The two separating method by a grouping manner as described above have advantages such as being advanced and reasonable, short process, low production cost, good adaptability, and easy operation and control. The method has better overall technical and economic indicator than the naphthenic acid process and has the value of practical application.

In order to solve the above technical problems, the technical solutions of the present disclosure are as follows.

In one aspect, the present disclosure provides a method for separating yttrium oxide from a high-yttrium rare earth ore by a grouping manner, comprising:

Step 1: separating a feed liquid of the high-yttrium rare earth ore with a P507 mixed system by an erbium-thulium grouping manner to obtain a yttrium-rich material (La—Er—Y group) as an aqueous raffinate phase and a thulium-ytterbium-lutetium-enriched material (Tm Yb Lu group) as an organic phase;

Step 2: separating the thulium-ytterbium-lutetium-enriched material into individual heavy rare earths with a P507 mixed system to obtain 3N-5N lutetium oxide, thulium oxide and ytterbium oxide;

Step 3: directly separating yttrium oxide from the yttrium-rich material with a mixed system of a carboxylic acid-based extractant HA and a phase modifier TBP (i.e., tributyl phosphate) to obtain a Y group as an aqueous raffinate phase and a La—Er group as an organic phase, precipitating the aqueous raffinate phase with oxalic acid, ammonium bicarbonate, or aqueous ammonia, and firing the precipitate to obtain 3N-5N yttrium oxide; and

Step 4: separating the La—Er group into other individual rare earths with the P507 system, precipitating a stripping solution with oxalic acid, ammonium bicarbonate, or aqueous ammonia, and firing the precipitate to obtain 3N-5N individual rare earth oxides.

As described above, the term “high-yttrium rare earth ore” refers to a rare earth ore which mainly contains heavy rare earth elements in an amount up to about 90%, typically contains yttrium oxide, terbium oxide, and dysprosium oxide, with mass fractions of 25-60%, 0.5-1.0% and 3-7% respectively.

In the present disclosure, “N” represents the relative purity of yttrium oxide. That is, “3N-5N yttrium oxide” represents yttrium oxide with a relative purity of 99.9%-99.999%.

In the technical solutions above, the P507 mixed system in both Step 1 and Step 2 is a P507 (2-ethylhexyl phosphonic acid mono-2-ethylhexyl ester)-isooctanol mixed system, a P507 (2-ethylhexyl phosphonic acid mono-2-ethylhexyl ester)-P227 (di(2-ethylhexyl)phosphonic acid) mixed system or a P507 (2-ethylhexyl phosphonic acid mono-2-ethylhexyl ester)-Cyanex272 mixed system.

In the technical solutions above, the P507 mixed system in Step 1 and Step 2 contains: 2-ethylhexyl phosphonic acid mono-2-ethylhexyl ester (P507); and one or more of isooctanol, di(2-ethylhexyl) phosphonic acid (P227), and bis(2,4,4-trimethylpentyl) phosphonic acid (Cyanex272).

In the technical solutions above, process parameters for separating the feed liquid of the high-yttrium rare earth ore with the P507-isooctanol mixed system by the erbium-thulium grouping manner in Step 1 are as follows: a P507 concentration of 1.0-1.5 mol/L, an isooctanol concentration of 10-30%, a saponification degree of 36%, and a hydrochloric acid concentration of 4.5-5.0 mol/L for stripping.

In the technical solutions above, process parameters for separating the feed liquid of the high-yttrium rare earth ore with the P507-P227 mixed system by the erbium-thulium grouping manner in Step 1 are as follows: a P507 concentration of 0.5-0.75 mol/L, a P227 concentration of 0.5-0.75 mol/L, a saponification degree of 36%, and a hydrochloric acid concentration of 2.5-3.5 mol/L for stripping.

In the technical solutions above, process parameters for separating the feed liquid of the high-yttrium rare earth ore with the P507-Cyanex272 mixed system by the erbium-thulium grouping manner in Step 1 are as follows: a P507 concentration of 0.5-0.75 mol/L, a Cyanex272 concentration of 0.5-0.75 mol/L, a saponification degree of 36%, and a hydrochloric acid concentration of 2.5-3.5 mol/L for stripping.

In the technical solutions above, the carboxylic acid-based extractant HA in Step 3 is sec-octyl phenoxyl substituted acetic acid (CA12) or sec-nonyl phenoxyl substituted acetic acid (CA100).

In the technical solutions above, process parameters for directly separating yttrium oxide from the yttrium-rich material with the mixed system of the carboxylic acid-based extractant HA and the phase modifier TBP in Step 3 are as follows: a HA concentration of 0.50-1.0 mol/L, a TBP concentration of 10-30%, a saponification degree of 80-90%, and a hydrochloric acid concentration of 2.0-3.0 mol/L for stripping.

In the technical solutions above, process parameters for separating the La—Er group into other individual rare earths with the P507 system in Step 4 are as follows: a P507 concentration of 1.0-1.5 mol/L, a saponification degree of 36%, and a hydrochloric acid concentration of 3.0 mol/L for stripping.

In another aspect, the present disclosure provides a method for separating yttrium oxide from a medium-yttrium and europium-rich rare earth ore by a grouping manner, comprising:

Step 1: separating a feed liquid of the medium-yttrium and europium-rich rare earth ore with a P507 mixed system by a dysprosium-holmium grouping manner to obtain a light and middle rare earth-enriched material (a La—Dy group) as an aqueous raffinate phase and a yttrium-rich material 1 (a Ho—Lu—Y group, wherein the weight percentage of Y₂O₃ is 83%) as an organic phase;

Step 2: separating the light and middle rare earth-enriched material into individual rare earths with a P507 system;

Step 3: separating the yttrium-rich material 1 with a P507 mixed system by an erbium-thulium grouping manner to obtain a yttrium-rich material 2 (a Ho Er Y group, wherein the weight percentage of Y₂O₃ is 88%) as an aqueous raffinate phase and a thulium-ytterbium-lutetium-enriched material as an organic phase, and then separating a stripping solution into individual heavy rare earths with the P507 mixed system to obtain 3N-5N lutetium oxide, thulium oxide and ytterbium oxide; and

Step 4: directly extraction separating yttrium oxide from the yttrium-rich material 2 with a mixed system of a carboxylic acid-based extractant HA and a phase modifier TBP to obtain a Y group as an aqueous raffinate phase and a Ho—Er group as an organic phase, precipitating the aqueous raffinate phase with oxalic acid, ammonium bicarbonate, or aqueous ammonia, and firing the precipitate to obtain a product of 3N-5N yttrium oxide.

As described above, the term “medium-yttrium and europium-rich rare earth ore” refers to a rare earth ore which contains light rare earths and heavy rare earths each in an amount of about 50%, typically, contains europium oxide and yttrium oxide, with mass fractions of 0.5-1.0% and 20-30% respectively.

In the present disclosure, “N” represents the relative purity of yttrium oxide. That is, “3N-5N yttrium oxide” represents yttrium oxide with a relative purity of 99.9%-99.999%.

In the technical solutions above, the P507 mixed systems used in both separating the feed liquid of the medium-yttrium and europium-rich rare earth ore by the dysprosium-holmium grouping manner in Step 1 and separating the yttrium-rich material 1 by the erbium-thulium grouping manner in Step 3 are a P507-isooctanol mixed system, a P507-P227 (di(2-ethylhexyl)phosphonic acid) mixed system or a P507-Cyanex272 mixed system.

In the technical solutions above, the P507 mixed system in Step 1 and Step 3 contains: 2-ethylhexyl phosphonic acid mono-2-ethylhexyl ester (P507); and one or more of isooctanol, di(2-ethylhexyl) phosphonic acid (P227), and bis(2,4,4-trimethylpentyl) phosphonic acid (Cyanex272).

In the technical solutions above, process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-isooctanol mixed system are as follows: a P507 concentration of 1.0-1.5 mol/L, an isooctanol concentration of 10-30%, a saponification degree of 36%, and a hydrochloric acid concentration of 4.5-5.0 mol/L for stripping.

In the technical solutions above, process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-Cyanex272 mixed system are as follows: a P507 concentration of 0.5-0.75 mol/L, a Cyanex272 concentration of 0.5-0.75 mol/L, a saponification degree of 36%, and a hydrochloric acid concentration of 2.5-3.5 mol/L for stripping.

In the technical solutions above, process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-P227 mixed system are as follows: a P507 concentration of 0.5-0.75 mol/L, a P227 concentration of 0.5-0.75 mol/L, a saponification degree of 36%, and a hydrochloric acid concentration of 2.5-3.5 mol/L for stripping.

In the technical solutions above, process parameters for separating the light and middle rare earth-enriched material into individual rare earths with the P507 system in Step 2 are as follows: a P507 concentration of 1.0-1.5 mol/L, a saponification degree of 36%, and a hydrochloric acid concentration of 3.5 mol/L for stripping.

In the technical solutions above, in Step 4, yttrium oxide is directly extraction separated from the yttrium-rich material 2 with the mixed system of the carboxylic acid-based extractant HA-TPB, wherein the carboxylic acid-based extractant HA is sec-octyl phenoxyl substituted acetic acid (CA12) or sec-nonyl phenoxyl substituted acetic acid (CA100).

In the technical solutions above, process parameters for directly extraction separating yttrium oxide from the yttrium-rich material 2 with the mixed system of the carboxylic acid-based extractant HA-TBP in Step 4 are as follows: a carboxylic acid-based extractant HA concentration of 0.50-1.0 mol/L, a TBP concentration of 10-30%, a saponification degree of 80-90%, and a hydrochloric acid concentration of 2.0-3.0 mol/L for stripping.

In the technical solutions above, the method of the present disclosure is suitable for separating yttrium oxide from a southern ion-adsorption rare earth ore, including a medium-yttrium and europium-rich rare earth ore, a low-yttrium mixed rare earth ore obtained after extracting yttrium from a high-yttrium ore, and a light rare earth ore by a grouping manner.

The present disclosure has the following advantageous effects.

In the method for separating yttrium oxide from a high-yttrium rare earth ore by a grouping manner provided in the present disclosure, Tm, Yb, and Lu are pre-separated with a P507-isooctanol mixed system or the like, and then yttrium oxide is extraction separated from a La—Er Y enriched material with a HA-TBP mixed system, avoiding the problem of low separation factor of Tm, Yb, Lu and Y in the HA system. The extraction separation of yttrium oxide from the La—Er Y enriched material with the HA-TBP mixed system avoids the problem that the changes in concentrations of two extractants are difficult to be rapidly analyzed on site when separating yttrium oxide from a feed liquid of a high-yttrium rare earth ore with the HAB system. In the pre-separation with a P507-isooctanol mixed system or the like by an erbium-thulium grouping manner, the fed rare earth has a high concentration and a large throughput, and thus heavy rare earth products such as lutetium can be preferentially separated. In comparison to the naphthenic acid process, the method has advantages such as short process, stable quality, high yield, good adaptability, stable composition, low water solubility, and unlikely emulsification during extraction, has better overall technical and economic indicator performance than the naphthenic acid process, and has the value of practical application. Therefore, the method can replace the existing naphthenic acid process for separating yttrium.

In the method for separating yttrium oxide from a medium-yttrium and europium-rich rare earth ore by a grouping manner provided in the present disclosure, Tm, Yb, and Lu are pre-separated with a P507-isooctanol mixed system or the like, and then yttrium oxide is extraction separated from a Ho Er Y enriched material with an HA-TBP mixed system, avoiding the problem of low separation factor of Tm, Yb, Lu and Y in the HA system. The extraction separation of yttrium oxide from the Ho Er Y enriched material with the HA-TBP mixed system avoids the problem that the changes in concentrations of two extractants are difficult to be rapidly analyzed on site when separating yttrium oxide from a yttrium-rich material with the HAB system and the problem of high cost of the HB component. The separation with the P507-isooctanol mixed system or the like by the dysprosium-holmium grouping manner can preferentially obtain valuable rare earth products of thulium oxide and lutetium oxide, and solve the problem that the stripping of thulium, ytterbium and lutetium is not complete in the existing P507 system (three grouping process), resulting in loss and waste of heavy rare earth resources. In comparison to the naphthenic acid process, the method has advantages such as short process, stable quality, high yield, good adaptability, stable composition, low water solubility, and unlikely emulsification during extraction, has better overall technical and economic indicator performance than the naphthenic acid process, and has the value of practical application. Therefore, the method can replace the existing naphthenic acid process for separating yttrium.

### BRIEF DESCRIPTION OF THE DRAWINGS

The present disclosure will be further described in detail below with reference to the drawings and particular embodiments.

FIG. 1 is a flow diagram of a process for separating yttrium oxide from a high-yttrium rare earth ore by a grouping manner provided in the present disclosure.

FIG. 2 is a flow diagram of a process for separating yttrium oxide from a medium-yttrium and europium-rich rare earth ore by a grouping manner provided in the present disclosure.

### DETAILED DESCRIPTION OF THE INVENTION

In one aspect, the present disclosure provides a method for separating yttrium oxide from a high-yttrium rare earth ore by a grouping manner.

In particular, the inventive concept of the present disclosure lies in the following fact. All current processes for separating yttrium oxide from a high-yttrium rare earth ore use the naphthenic acid system to directly separate yttrium oxide. In order to solve the technical problems existed in the naphthenic acid system process for separating yttrium, the inventors have made an HAB double solvent extraction system (Chinese Patent No.: ZL 99118261.8). The HAB process is superior to the naphthenic acid extraction process under the same conditions. However, the HAB system suffers from the problem in long term use that the changes in concentrations of two extractants are difficult to be rapidly analyzed on site, which limits its industrial application. In order to solve the technical problems existed in the separation of yttrium oxide with the naphthenic acid system and the HAB system, the present disclosure provides a method for separating yttrium oxide from a high-yttrium rare earth ore by a grouping manner. In the method, the high-yttrium rare earth ore is firstly separated with a mixed system P507-isooctanol or the like by an erbium-thulium grouping manner to obtain a high-yttrium enriched material and a thulium-ytterbium-lutetium-enriched material, the thulium-ytterbium-lutetium-enriched material is further separated to prepare heavy rare earths such as lutetium oxide, then the high-yttrium enriched material is separated with a mixed system of a carboxylic acid-based extractant HA-TBP to prepare yttrium oxide, and finally the La—Er enriched material is separated into other individual rare earths with a P507 system by a grouping manner.

The method for separating yttrium oxide from a high-yttrium rare earth ore by a grouping manner provided in the present disclosure does not use an HA system to directly separate yttrium oxide, but pre-separates heavy rare earths of thulium, ytterbium and lutetium with a P507-isooctanol mixed system, and then separates yttrium oxide with an HA mixed system. The main reason lies in that: the separation factor of La/Y in the HA is 3.0-4.9, which is significantly better than that in the naphthenic acid system, but the separation factor of Tm, Yb, Lu and Y is 1.4-1.7, which is lower than that in the naphthenic acid system, so it is difficult to directly separate yttrium from a yttrium-containing heavy rare earth mixture with the HA system, which is not suitable for industrial production. The pre-separation of Tm, Yb and Lu with the mixed system of P507-isooctanol or the like can avoid the problem of low separation factor of Tm, Yb, Lu and Y in the HA system.

The method for separating yttrium oxide from a high-yttrium rare earth ore by a grouping manner mainly has the following advantages.

(1) In the method for separating yttrium oxide from a high-yttrium rare earth ore by a grouping manner provided in the present disclosure, Tm, Yb, and Lu are pre-separated with a mixed system of P507-isooctanol or the like, and then yttrium oxide is extraction separated from a La—Er Y enriched material with an HA system, avoiding the problem of low separation coefficients of Tm, Yb, Lu and Y in the HA system.

(2) In the method for separating yttrium oxide from a high-yttrium rare earth ore by a grouping manner provided in the present disclosure, yttrium oxide is extraction separated from a La—Er Y enriched material with an HA system, avoiding the problem that the changes in concentrations of two extractants are difficult to be rapidly analyzed on site when separating yttrium oxide from a feed liquid of a high-yttrium rare earth ore with the HAB system.

(3) In the method for separating yttrium oxide from a high-yttrium rare earth ore by a grouping manner provided in the present disclosure, in the pre-separation with a mixed system of P507-isooctanol or the like by an erbium-thulium grouping manner, the fed rare earth has a high concentration and a large throughput, and thus heavy rare earth products such as lutetium can be preferentially separated.

(4) In the method for separating yttrium oxide from a high-yttrium rare earth ore by a grouping manner provided in the present disclosure, in comparison to the naphthenic acid process, the method has advantages such as short process, stable quality, high yield, good adaptability, stable composition, low water solubility, and unlikely emulsification during extraction, has better overall technical and economic indicator performance than the naphthenic acid process, and has the value of practical application. Therefore, the method can replace the existing naphthenic acid process for separating yttrium.

The present disclosure will be described in detail below with reference to the drawings.

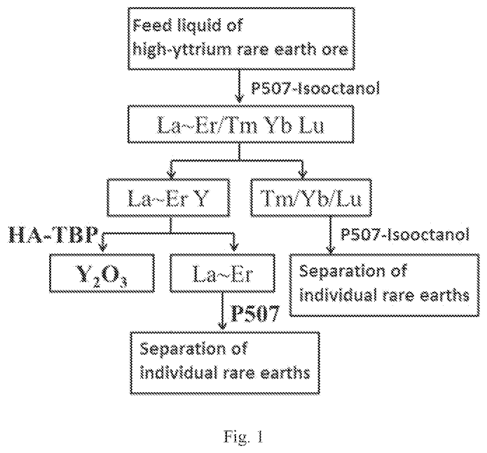

The method for separating yttrium oxide from a high-yttrium rare earth ore by a grouping manner provided in the present disclosure will be described with reference to FIG. 1, the method comprising:

Step 1: separating a feed liquid of the high-yttrium rare earth ore with a P507 mixed system (for example, P507-isooctanol) by an erbium-thulium grouping manner to obtain a yttrium-rich material (La—Er Y group) as an aqueous raffinate phase and a thulium-ytterbium-lutetium-enriched material (Tm Yb Lu group) as an organic phase;

Step 2: separating the thulium-ytterbium-lutetium-enriched material into individual heavy rare earths with a P507 mixed system (for example, P507-isooctanol) to obtain 3N-5N lutetium oxide, thulium oxide and ytterbium oxide;

Step 3: directly separating yttrium oxide from the yttrium-rich material with a mixed system of a carboxylic acid-based extractant HA and a phase modifier TBP to obtain a Y group as an aqueous raffinate phase and a La—Er group as an organic phase, precipitating the aqueous raffinate phase with oxalic acid, ammonium bicarbonate, or aqueous ammonia, and firing the precipitate to obtain 3N-5N yttrium oxide; and

Step 4: separating the La—Er group into other individual rare earths with the P507 system, precipitating a stripping solution with oxalic acid, ammonium bicarbonate, or aqueous ammonia, and firing the precipitate to obtain 3N-5N individual rare earth oxides.

Preferably, the P507 mixed systems in both Step 1 and Step 2 are a P507-isooctanol mixed system, a P507-P227 (di(2-ethylhexyl) phosphonic acid) mixed system or a P507-Cyanex272 mixed system.

Preferably, process parameters for separating the feed liquid of the high-yttrium rare earth ore with the P507-isooctanol mixed system by the erbium-thulium grouping manner in Step 1 are as follows: a P507 concentration of 1.0-1.5 mol/L, an isooctanol concentration of 10-30%, a saponification degree of 36%, and a hydrochloric acid concentration of 4.5-5.0 mol/L for stripping.

Preferably, process parameters for separating the feed liquid of the high-yttrium rare earth ore with the P507-P227 mixed system by the erbium-thulium grouping manner in Step 1 are as follows: a P507 concentration of 0.5-0.75 mol/L, a P227 concentration of 0.5-0.75 mol/L, a saponification degree of 36%, and a hydrochloric acid concentration of 2.5-3.5 mol/L for stripping.

Preferably, process parameters for separating the feed liquid of the high-yttrium rare earth ore with the P507-Cyanex272 mixed system by the erbium-thulium grouping manner in Step 1 are as follows: a P507 concentration of 0.5-0.75 mol/L, a Cyanex272 concentration of 0.5-0.75 mol/L, a saponification degree of 36%, and a hydrochloric acid concentration of 2.5-3.5 mol/L for stripping.

Preferably, the carboxylic acid-based extractant HA in Step 3 is sec-octyl phenoxyl substituted acetic acid (CA12) or sec-nonyl phenoxyl substituted acetic acid (CA100).

Preferably, process parameters for directly separating yttrium oxide from the yttrium-rich material with the mixed system of the carboxylic acid-based extractant HA and the phase modifier TBP in Step 3 are as follows: a HA concentration of 0.50-1.0 mol/L, a TBP concentration of 10-30%, a saponification degree of 80-90%, and a hydrochloric acid concentration of 2.0-3.0 mol/L for stripping.

Preferably, process parameters for separating the La—Er group into other individual rare earths with the P507 system in Step 4 are as follows: a P507 concentration of 1.0-1.5 mol/L, a saponification degree of 36%, and a hydrochloric acid concentration of 3.0 mol/L for stripping.

In another aspect, the present disclosure provides a method for separating yttrium oxide from a medium-yttrium and europium-rich rare earth ore by a grouping manner.

In particular, the inventive concept of the present disclosure lies in the following fact. The main process for the current process for the separation of a medium-yttrium and europium-rich rare earth ore mainly comprises: the rare earth ore is firstly separated with a P507 (2-ethylhexyl phosphonic acid mono-2-ethylhexyl ester) system into three groups, i.e., La—Ce—Pr—Nd, Sm—Eu—Gd—Tb—Dy, and Ho—Er—Tm—Yb—Lu—Y (yttrium-rich material), then yttrium oxide is directly separated from the yttrium-rich material with naphthenic acid, individual light and middle rare earths are separated with a P507 system, and heavy rare earths of thulium, ytterbium and lutetium are separated with a P507-isooctanol mixed system. In order to solve the technical problems existed in the naphthenic acid system process for separating yttrium, the inventors have developed an HAB double solvent extraction system (Chinese Patent No.: ZL 99118261.8). The HAB process is superior to the naphthenic acid extraction process under the same conditions. However, the HAB system suffers from the problem in long term use that the changes in concentrations of two extractants are difficult to be rapidly analyzed on site, which limits its industrial application. In order to solve the technical problems existed in the separation of yttrium oxide with the naphthenic acid system and the HAB system, the present disclosure provides a method for separating yttrium oxide from a medium-yttrium and europium-rich rare earth ore by a grouping manner. In the method, the medium-yttrium and europium-rich rare earth ore is firstly separated with a mixed system of P507-isooctanol or the like by a dysprosium-holmium grouping manner to obtain a yttrium-rich material 1 (Ho—Lu Y) and a light and middle rare earth-enriched material (La—Dy), the light and middle rare earth-enriched material is further separated into individual rare earths with a P507 system; then the yttrium-rich material 1 is separated with a P507-isooctanol mixed system or the like by an erbium-thulium grouping manner to obtain a yttrium-rich material 2 (Ho—Er—Y) and a thulium-ytterbium-lutetium-enriched material, the thulium-ytterbium-lutetium-enriched material is further separated into individual heavy rare earths; and finally the yttrium-rich material 2 is separated with an HA-TBP mixed system to prepare yttrium oxide.

The method for separating yttrium oxide from a medium-yttrium and europium-rich rare earth ore by a grouping manner provided in the present disclosure does not directly use a P507 system to separate the rare earth ore into three groups, but uses a mixed system of P507-isooctanol or the like to separate the rare earth ore by a grouping manner. The main reason lies in that: in the process for separating a heave rare earth from a southern ion-adsorption ore, the P507 system has the problems of low separation efficiency of heavy rare earth, high stripping acidity, incomplete stripping and so on. The separation with the mixed system of P507-isooctanol or the like by the dysprosium-holmium grouping manner can preferentially obtain valuable rare earth products of thulium oxide and lutetium oxide, and solve the problem that the stripping of thulium, ytterbium and lutetium is not complete in the existing P507 system three group process, which results in loss and waste of heavy rare earth resources.

In the method for separating yttrium oxide from a medium-yttrium and europium-rich rare earth ore by a grouping manner provided in the present disclosure, the yttrium-rich material (Ho—Lu—Y) is not directly separated with a HA system to obtain yttrium oxide, but is separated with a mixed system of P507-isooctanol or the like by a dysprosium-holmium grouping manner, and then separated with a HA mixed system to obtain yttrium oxide. The main reason lies in that: the separation factor of LaN in the HA is 3.0-4.9, which is significantly better than that in the naphthenic acid system, but the separation factor of Tm, Yb, Lu and Y is 1.4-1.7, which is lower than that in the naphthenic acid system, so it is difficult to directly separate yttrium from a yttrium-containing heavy rare earth mixture with the HA system, which is not suitable for industrial production. The pre-separation of Tm, Yb and Lu with the mixed system of P507-isooctanol or the like can avoid the problem of low separation factor of Tm, Yb, Lu and Y in the HA system.

The method for separating yttrium oxide from a medium-yttrium and europium-rich rare earth ore by a grouping manner mainly has the following advantages.

(1) In the method for separating yttrium oxide from a medium-yttrium and europium-rich rare earth ore by a grouping manner provided in the present disclosure, the separation with the mixed system of P507-isooctanol or the like by the dysprosium-holmium grouping manner can preferentially obtain valuable rare earth products of thulium oxide and lutetium oxide, and solve the problem that the stripping of thulium, ytterbium and lutetium is not complete in the existing P507 system three group process, resulting in loss and waste of heavy rare earth resources.

(2) In the method for separating yttrium oxide from a medium-yttrium and europium-rich rare earth ore by a grouping manner provided in the present disclosure, Tm, Yb, and Lu are pre-separated with a mixed system of P507-isooctanol or the like, and then yttrium oxide is extraction separated from a Ho—Er—Y-enriched material with a HA-TBP mixed system, avoiding the problem of low separation factor of Tm, Yb, Lu and Y in the HA system.

(3) In the method for separating yttrium oxide from a medium-yttrium and europium-rich rare earth ore by a grouping manner provided in the present disclosure, yttrium oxide is extraction separated from a Ho—Er—Y-enriched material with a HA-TBP mixed system, avoiding the problem that the changes in concentrations of two extractants are difficult to be rapidly analyzed on site when separating yttrium oxide from a yttrium-rich material with the HAB system.

(4) In the method for separating yttrium oxide from a medium-yttrium and europium-rich rare earth ore by a grouping manner provided in the present disclosure, in comparison to the naphthenic acid process, the method has advantages such as short process, stable quality, high yield, good adaptability, stable composition, low water solubility, and unlikely emulsification during extraction or the like, has better overall technical and economic indicator performance than the naphthenic acid process, and has the value of practical application. Therefore, the method can replace the existing naphthenic acid process for separating yttrium.

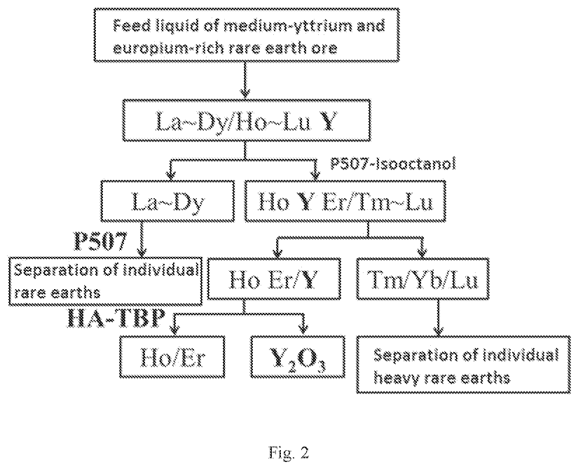

The method for separating yttrium oxide from a medium-yttrium and europium-rich rare earth ore by a grouping manner provided in the present disclosure will be described in detail with reference to FIG. 2, the method comprising:

Step 1: separating a feed liquid of the medium-yttrium and europium-rich rare earth ore with a P507 mixed system (for example, P507-isooctanol) by a dysprosium-holmium grouping manner to obtain a light and middle rare earth-enriched material (La—Dy group) as an aqueous raffinate phase and a yttrium-rich material 1 (Ho—Lu—Y group, wherein the weight percentage of Y₂O₃ is 83%) as an organic phase;

Step 2: separating the light and middle rare earth-enriched material into individual rare earths with a P507 system;

Step 3: separating the yttrium-rich material 1 with a P507 mixed system (for example, P507-isooctanol) by an erbium-thulium grouping manner to obtain a yttrium-rich material 2 (Ho—Er—Y group, wherein the weight percentage of Y₂O₃ is 88%) as an aqueous raffinate phase and a thulium-ytterbium-lutetium-enriched material as an organic phase, and then separating a stripping solution into individual heavy rare earths with the P507 mixed system (for example, P507-isooctanol) to obtain 3N-5N lutetium oxide, thulium oxide and ytterbium oxide; and

Step 4: directly extraction separating yttrium oxide from the yttrium-rich material 2 with a mixed system of a carboxylic acid-based extractant HA-TBP to obtain a Y group as an aqueous raffinate phase and a Ho—Er group as an organic phase, precipitating the aqueous raffinate phase with oxalic acid, ammonium bicarbonate, or aqueous ammonia, and firing the precipitate to obtain a product of 3N-5N yttrium oxide.

Preferably, the P507 mixed systems used in both separating the feed liquid of the medium-yttrium and europium-rich rare earth ore by the dysprosium-holmium grouping manner in Step 1 and separating the yttrium-rich material 1 by the erbium-thulium grouping manner in Step 3 are a P507-isooctanol mixed system, a P507-P227 (di(2-ethylhexyl)phosphonic acid) mixed system or a P507-Cyanex272 mixed system.

Preferably, process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-isooctanol mixed system are as follows: a P507 concentration of 1.0-1.5 mol/L, an isooctanol concentration of 10-30%, a saponification degree of 36%, and a hydrochloric acid concentration of 4.5-5.0 mol/L for stripping.

Preferably, process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-Cyanex272 mixed system are as follows: a P507 concentration of 0.5-0.75 mol/L, a Cyanex272 concentration of 0.5-0.75 mol/L, a saponification degree of 36%, and a hydrochloric acid concentration of 2.5-3.5 mol/L for stripping.

Preferably, process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-P227 mixed system are as follows: a P507 concentration of 0.5-0.75 mol/L, a P227 concentration of 0.5-0.75 mol/L, a saponification degree of 36%, and a hydrochloric acid concentration of 2.5-3.5 mol/L for stripping.

Preferably, process parameters for separating the light and middle rare earth-enriched material into individual rare earths with the P507 system in Step 2 are as follows: a P507 concentration of 1.0-1.5 mol/L, a saponification degree of 36%, and a hydrochloric acid concentration of 3.5 mol/L for stripping.

Preferably, in Step 4, yttrium oxide is directly extraction separated from the yttrium-rich material 2 with the mixed system of the carboxylic acid-based extractant HA-TPB, wherein the carboxylic acid-based extractant HA is sec-octyl phenoxyl substituted acetic acid (CA12) or sec-nonyl phenoxyl substituted acetic acid (CA100).

Preferably, process parameters for directly extraction separating yttrium oxide from the yttrium-rich material 2 with the mixed system of the carboxylic acid-based extractant HA-TBP in Step 4 are as follows: a carboxylic acid-based extractant HA concentration of 0.50-1.0 mol/L, a TBP concentration of 10-30%, a saponification degree of 80-90%, and a hydrochloric acid concentration of 2.0-3.0 mol/L for stripping.

The method of the present disclosure is suitable for group separating yttrium oxide from a southern ion-adsorption rare earth ore, including a medium-yttrium and europium-rich rare earth ore, a low-yttrium mixed rare earth ore obtained after extracting yttrium from a high-yttrium ore, and a light rare earth ore.

The present disclosure will be described in further detail below with reference to the Examples. It should be noted that all these descriptions and examples are for the purpose of better understanding of the present disclosure, but not intended for limiting. The protection scope of the present invention is defined by the appended claims.

### EXAMPLES

In the present disclosure, unless indicated otherwise, all the reagents used are commercially available products and can be directly used without further purification. In addition, unless specified otherwise, the reference to “%” means “wt %”.

The following Examples 1-4 relate to methods for separating yttrium oxide from a high-yttrium rare earth ore by a grouping manner of the present disclosure.

### Example 1

Step 1: A feed liquid of a high-yttrium rare earth ore was separated with a mixed system of 1.0 mol/L P507-20% isooctanol by an erbium-thulium grouping manner with a saponification degree of 36%, and the organic phase was stripped with 5 mol/L hydrochloric acid, obtaining a La—Er—Y group (a yttrium-rich material) as an aqueous raffinate phase, and a Tm—Yb—Lu group (a thulium-ytterbium-lutetium-enriched material) as an organic phase. The thulium-ytterbium-lutetium-enriched material was then separated into individual heavy rare earths with a mixed system of 1.0 mol/L P507-20% isooctanol to obtain 5N lutetium oxide, 3N thulium oxide, and 5N ytterbium oxide.

Step 2: Yttrium oxide was directly extraction separated from the yttrium-rich material liquid with a mixed system of 0.50 mol/L CA12-10% TBP with a saponification degree of 80%, and the organic phase was stripped with 3 mol/L hydrochloric acid, obtaining a Y group as an aqueous raffinate phase and a La—Er group as an organic phase, the aqueous raffinate phase was precipitated with ammonium bicarbonate, and the precipitate was fired to obtain 3N yttrium oxide with a yield >96%.

Step 3: The La—Er group was separated into individual rare earths with 1.5 mol/L P507 system with a saponification degree of 36%, the organic phase was stripped with 3 mol/L hydrochloric acid, the stripping solution was precipitated with oxalic acid, ammonium bicarbonate, or aqueous ammonia, and the precipitate was fired to obtain 3N-5N individual rare earth oxides.

### Example 2

Step 1: A feed liquid of a high-yttrium rare earth ore was separated with a mixed system of 0.5 mol/L P507-0.5 mol/L Cyanex272 by an erbium-thulium grouping manner with a saponification degree of 36%, and the organic phase was stripped with 3.5 mol/L hydrochloric acid, obtaining a La—Er—Y group (a yttrium-rich material) as an aqueous raffinate phase, and a Tm—Yb—Lu group (a thulium-ytterbium-lutetium-enriched material) as an organic phase. The thulium-ytterbium-lutetium-enriched material was then separated into individual heavy rare earths with the mixed system of 0.5 mol/L P507-0.5 mol/L Cyanex272 to obtain 4N lutetium oxide, 4N thulium oxide, and 4N ytterbium oxide.

Step 2: Yttrium oxide was directly extraction separated from the yttrium-rich material liquid with a mixed system of 0.8 mol/L CA12-20% TBP with a saponification degree of 90%, and the organic phase was stripped with 3.0 mol/L hydrochloric acid, obtaining a Y group as an aqueous raffinate phase and a La—Er group as an organic phase, the aqueous raffinate phase was precipitated with oxalic acid, and the precipitate was fired to obtain 5N yttrium oxide with a yield >96%.

Step 3: The La—Er group was separated into individual rare earths with 1.0 mol/L P507 system with a saponification degree of 36%, the organic phase was stripped with 3 mol/L hydrochloric acid, the stripping solution was precipitated with oxalic acid, ammonium bicarbonate, or aqueous ammonia, and the precipitate was fired to obtain 3N-5N individual rare earth oxides.

### Example 3

Step 1: A feed liquid of a high-yttrium rare earth ore was separated with a mixed system of 0.5 mol/L P507-0.5 mol/L P227 by an erbium-thulium grouping manner with a saponification degree of 36%, and the organic phase was stripped with 3 mol/L hydrochloric acid, obtaining a La—Er—Y group (a yttrium-rich material) as an aqueous raffinate phase, and a Tm—Yb—Lu group (a thulium-ytterbium-lutetium-enriched material) as an organic phase. The thulium-ytterbium-lutetium-enriched material was then separated into individual heavy rare earths with the mixed system of 0.5 mol/L P507-0.5 mol/L P227 to obtain 5N lutetium oxide, 4N thulium oxide, and 4N ytterbium oxide.

Step 2: Yttrium oxide was directly extraction separated from the yttrium-rich material liquid with a mixed system of 0.8 mol/L CA100-20% TBP with a saponification degree of 90%, and the organic phase was stripped with 3.0 mol/L hydrochloric acid, obtaining a Y group as an aqueous raffinate phase and a La—Er group as an organic phase, the aqueous raffinate phase was precipitated with oxalic acid, and the precipitate was fired to obtain 5N yttrium oxide with a yield >96%.

Step 3: The La—Er group was separated into individual rare earths with 1.5 mol/L P507 system with a saponification degree of 36%, the organic phase was stripped with 3 mol/L hydrochloric acid, the stripping solution was precipitated with oxalic acid, ammonium bicarbonate, or aqueous ammonia, and the precipitate was fired to obtain a product of 3N-5N individual rare earth oxide.

### Example 4

Step 1: A feed liquid of a high-yttrium rare earth ore was separated with a mixed system of 1.2 mol/L P507-15% isooctanol by an erbium-thulium grouping manner with a saponification degree of 36%, and the organic phase was stripped with 4.5 mol/L hydrochloric acid, obtaining a La—Er—Y group (a yttrium-rich material) as an aqueous raffinate phase, and a Tm—Yb—Lu group (a thulium-ytterbium-lutetium-enriched material) as an organic phase. The thulium-ytterbium-lutetium-enriched material was then separated into individual heavy rare earths with the mixed system of 1.2 mol/L P507-15% isooctanol to obtain 5N lutetium oxide, 4N thulium oxide, and 4N ytterbium oxide.

Step 2: Yttrium oxide was directly extraction separated from the yttrium-rich material liquid with a mixed system of 1 mol/L CA12-30% TBP with a saponification degree of 90%, and the organic phase was stripped with 3.0 mol/L hydrochloric acid, obtaining a Y group as an aqueous raffinate phase and a La—Er group as an organic phase, the aqueous raffinate phase was precipitated with oxalic acid, and the precipitate was fired to obtain 5N yttrium oxide with a yield >96%.

Step 3: The La—Er group was separated into individual rare earths with 1.2 mol/L P507 system with a saponification degree of 36%, the organic phase was stripped with 3 mol/L hydrochloric acid, the stripping solution was precipitated with oxalic acid, ammonium bicarbonate, or aqueous ammonia, and the precipitate was fired to obtain 3N-5N individual rare earth oxides.

The following Examples 5-8 relate to methods for separating yttrium oxide from a high-yttrium rare earth ore by a grouping manner of the present disclosure.

### Example 5

Step 1: a feed liquid of a medium-yttrium and europium-rich rare earth ore was separated with a mixed system of 1.0 mol/L P507-20% isooctanol by a dysprosium-holmium grouping manner with a saponification degree of 36%, and the organic phase was stripped with 5 mol/L hydrochloric acid, obtaining a light and middle rare earth-enriched material (a La—Dy group) as an aqueous raffinate phase and a yttrium-rich material 1 (a Ho—Lu—Y group) as an organic phase in which the weight percentage of Y₂O₃ was 83%. The light and middle rare earth-enriched material was separated into individual rare earths with a 1.5 mol/L P507 system with a saponification degree of 36%, and the organic phase was stripped with 3.5 mol/L hydrochloric acid.

Step 2: The yttrium-rich material 1 was separated with a mixed system of 1.2 mol/L P507-20% isooctanol by an erbium-thulium grouping manner, obtaining a yttrium-rich material 2 (a Ho—Er—Y group) as an aqueous raffinate phase in which the weight percentage of Y₂O₃ was increased to 88%, and a thulium-ytterbium-lutetium-enriched material as an organic phase, and the stripping solution was then separated into individual heavy rare earths with a mixed system of 1.2 mol/L P507-20% isooctanol, obtaining 3N-5N lutetium oxide, thulium oxide, and ytterbium oxide.

Step 3: Yttrium oxide was directly extraction separated from the yttrium-rich material 2 with a system of 0.50 mol/L CA12-10% TBP with a saponification degree of 80%, and the organic phase was stripped with 3 mol/L hydrochloric acid, obtaining a Y group as an aqueous raffinate phase and a Ho—Er group as an organic phase, the aqueous raffinate phase was precipitated with ammonium bicarbonate, and the precipitate was fired to obtain 3N yttrium oxide with a yield >96%.

### Example 6

Step 1: A feed liquid of a medium-yttrium and europium-rich rare earth ore was separated with a mixed system of 0.5 mol/L P507-0.5 mol/L Cyanex272 by a dysprosium-holmium grouping manner with a saponification degree of 36%, and the organic phase was stripped with 3.5 mol/L hydrochloric acid, obtaining a light and middle rare earth-enriched material (a La—Dy group) as an aqueous raffinate phase and a yttrium-rich material 1 (a Ho—Lu—Y group) as an organic phase in which the weight percentage of Y₂O₃ was 83%. The light and middle rare earth-enriched material was separated into individual rare earths with 1.0 mol/L P507 system with a saponification degree of 36%, and the organic phase was stripped with 3.0 mol/L hydrochloric acid.

Step 2: The yttrium-rich material 1 was separated with the mixed system of 0.5 mol/L P507-0.5 mol/L Cyanex272 by an erbium-thulium grouping manner, obtaining a yttrium-rich material 2 (a Ho—Er—Y group) as an aqueous raffinate phase in which the weight percentage of Y₂O₃ was increased to 88%, and a thulium-ytterbium-lutetium-enriched material as an organic phase, and the stripping solution was then separated into individual heavy rare earths with a mixed system of 0.5 mol/L P507-0.5 mol/L Cyanex272, obtaining 3N-5N lutetium oxide, thulium oxide, and ytterbium oxide.

Step 3: Yttrium oxide was directly extraction separated from the yttrium-rich material 2 with a system of 0.8 mol/L CA12-20% TBP with a saponification degree of 90%, and the organic phase was stripped with 3.0 mol/L hydrochloric acid, obtaining a Y group as an aqueous raffinate phase and a Ho—Er group as an organic phase, the aqueous raffinate phase was precipitated with oxalic acid, and the precipitate was fired to obtain 5N yttrium oxide with a yield >96%.

### Example 7

Step 1: A feed liquid of a medium-yttrium and europium-rich rare earth ore was separated with a mixed system of 0.5 mol/L P507-0.5 mol/L P227 by a dysprosium-holmium grouping manner with a saponification degree of 36%, and the organic phase was stripped with 3 mol/L hydrochloric acid, obtaining a light and middle rare earth-enriched material (a La—Dy group) as an aqueous raffinate phase and a yttrium-rich material 1 (a Ho—Lu—Y group) as an organic phase in which the weight percentage of Y₂O₃ was 83%. The light and middle rare earth-enriched material was separated into individual rare earths with 1.2 mol/L P507 system with a saponification degree of 36%, and the organic phase was stripped with 3.5 mol/L hydrochloric acid.

Step 2: The yttrium-rich material 1 was separated with the mixed system of 0.5 mol/L P507-0.5 mol/L P227 by an erbium-thulium grouping manner, obtaining a yttrium-rich material 2 (a Ho—Er—Y group) as an aqueous raffinate phase in which the weight percentage of Y₂O₃ was increased to 88%, and a thulium-ytterbium-lutetium-enriched material as an organic phase, then the stripping solution was separated into individual heavy rare earths with the mixed system of 0.5 mol/L P507-0.5 mol/L P227 to obtain 3N-5N lutetium oxide, thulium oxide and ytterbium oxide.

Step 3: Yttrium oxide was directly extraction separated from the yttrium-rich material 2 with a system of 0.8 mol/L CA100-20% TBP with a saponification degree of 90%, and the organic phase was stripped with 3 mol/L hydrochloric acid, obtaining a Y group as an aqueous raffinate phase and a Ho—Er group as an organic phase, the aqueous raffinate phase was precipitated with aqueous ammonia, and the precipitate was fired to obtain 5N yttrium oxide with a yield >96%.

### Example 8

Step 1: A feed liquid of a medium-yttrium and europium-rich rare earth ore was separated with a mixed system of 1.2 mol/L P507-15% isooctanol by a dysprosium-holmium grouping manner with a saponification degree of 36%, and the organic phase was stripped with 4.5 mol/L hydrochloric acid, obtaining a light and middle rare earth-enriched material (a La—Dy group) as an aqueous raffinate phase and a yttrium-rich material 1 (a Ho—Lu—Y group) as an organic phase in which the weight percentage of Y₂O₃ was 83%. The light and middle rare earth-enriched material was separated into individual rare earths with a 1.2 mol/L P507 system with a saponification degree of 36%, and the organic phase was stripped with 3.5 mol/L hydrochloric acid.

Step 2: The yttrium-rich material 1 was separated with a mixed system of 1.2 mol/L P507-15% isooctanol by an erbium-thulium grouping manner, obtaining a yttrium-rich material 2 (a Ho—Er—Y group) as an aqueous raffinate phase in which the weight percentage of Y₂O₃ was increased to 88%, and a thulium-ytterbium-lutetium-enriched material as an organic phase, and the stripping solution was then separated into individual heavy rare earths with a mixed system of 1.2 mol/L P507-15% isooctanol, obtaining 3N-5N lutetium oxide, thulium oxide, and ytterbium oxide.

Step 3: Yttrium oxide was directly extraction separated from the yttrium-rich material 2 with a system of 1 mol/L CA12-30% TBP with a saponification degree of 90%, and the organic phase was stripped with 3 mol/L hydrochloric acid, obtaining a Y group as an aqueous raffinate phase and a Ho—Er group as an organic phase, the aqueous raffinate phase was precipitated with oxalic acid, and the precipitate was fired to obtain 5N yttrium oxide with a yield >96%.

Obviously, the above Examples are only intended to clearly illustrate the present disclosure, but not intended to limit the embodiments. Other different forms of changes or modifications can be made by those skilled in the art based on the above description. All the embodiments have not to and cannot be provided exhaustively. Apparent changes or modification derived therefrom fall within the protection scope of the present invention.

What is claimed is:

1. A method for separating yttrium oxide from a high-yttrium rare earth ore by a grouping manner, comprising:
Step 1: separating a feed liquid of the high-yttrium rare earth ore with a P507 mixed system by an erbium-thulium grouping manner to obtain a yttrium-rich material as an aqueous raffinate phase and a thulium-ytterbium-lutetium-enriched material as an organic phase;
Step 2: separating the thulium-ytterbium-lutetium-enriched material into individual heavy rare earths with a P507 mixed system to obtain 3N-5N lutetium oxide, thulium oxide and ytterbium oxide;
Step 3: directly separating yttrium oxide from the yttrium-rich material with a mixed system of a carboxylic acid-based extractant HA and a phase modifier TBP to obtain a Y group as an aqueous raffinate phase and a La—Er group as an organic phase, precipitating the aqueous raffinate phase with oxalic acid, ammonium bicarbonate, or aqueous ammonia, and firing the precipitate to obtain 3N-5N yttrium oxide; and
Step 4: separating the La—Er group into other individual rare earths with the P507 system, precipitating a stripping solution with oxalic acid, ammonium bicarbonate, or aqueous ammonia, and firing the precipitate to obtain 3N-5N individual rare earth oxides.

2. The method according to claim 1, wherein the P507 mixed systems in Step 1 and Step 2 are a P507-isooctanol mixed system, a P507-P227 mixed system or a P507-Cyanex272 mixed system.

3. The method according to claim 2, wherein process parameters for separating the feed liquid of the high-yttrium rare earth ore with the P507-isooctanol mixed system by the erbium-thulium grouping manner in Step 1 are as follows: a P507 concentration of 1.0-1.5 mol/L, an isooctanol concentration of 10-30%, a saponification degree of 36%, and a hydrochloric acid concentration of 4.5-5.0 mol/L for stripping.

4. The method according to claim 2, wherein process parameters for separating the feed liquid of the high-yttrium rare earth ore with the P507-P227 mixed system by the erbium-thulium grouping manner in Step 1 are as follows: a P507 concentration of 0.5-0.75 mol/L, a P227 concentration of 0.5-0.75 mol/L, a saponification degree of 36%, and a hydrochloric acid concentration of 2.5-3.5 mol/L for stripping.

5. The method according to claim 2, wherein process parameters for separating the feed liquid of the high-yttrium rare earth ore with the P507-Cyanex272 mixed system by the erbium-thulium grouping manner in Step 1 are as follows: a P507 concentration of 0.5-0.75 mol/L, a Cyanex272 concentration of 0.5-0.75 mol/L, a saponification degree of 36%, and a hydrochloric acid concentration of 2.5-3.5 mol/L for stripping.

6. The method according to claim 1, wherein the carboxylic acid-based extractant HA in Step 3 is sec-octyl phenoxyl substituted acetic acid or sec-nonyl phenoxyl substituted acetic acid.

7. The method according to claim 1, wherein process parameters for directly separating yttrium oxide from the yttrium-rich material with the mixed system of the carboxylic acid-based extractant HA and the phase modifier TBP in Step 3 are as follows: a HA concentration of 0.50-1.0 mol/L, a TBP concentration of 10-30%, a saponification degree of 80-90%, and a hydrochloric acid concentration of 2.0-3.0 mol/L for stripping.

8. The method according to claim 1, wherein process parameters for separating the La—Er group into other individual rare earths with the P507 system in Step 4 are as follows: a P507 concentration of 1.0-1.5 mol/L, a saponification degree of 36%, and a hydrochloric acid concentration of 3.0 mol/L for stripping.

9. A method for separating yttrium oxide from a medium-yttrium and europium-rich rare earth ore by a grouping manner, comprising:
Step 1: separating a feed liquid of the medium-yttrium and europium-rich rare earth ore with a P507 mixed system by a dysprosium-holmium grouping manner to obtain a light and middle rare earth-enriched material as an aqueous raffinate phase and a yttrium-rich material 1 as an organic phase;
Step 2: separating the light and middle rare earth-enriched material into individual rare earths with a P507 system;
Step 3: separating the yttrium-rich material 1 with a P507 mixed system by an erbium-thulium grouping manner to obtain a yttrium-rich material 2 as an aqueous raffinate phase and a thulium-ytterbium-lutetium-enriched material as an organic phase, and then separating a stripping solution into individual heavy rare earths with the P507 mixed system to obtain 3N-5N lutetium oxide, thulium oxide and ytterbium oxide; and
Step 4: directly extraction separating yttrium oxide from the yttrium-rich material 2 with a mixed system of a carboxylic acid-based extractant HA and a phase modifier TBP to obtain a Y group as an aqueous raffinate phase and a Ho—Er group as an organic phase, precipitating the aqueous raffinate phase with oxalic acid, ammonium bicarbonate, or aqueous ammonia, and firing the precipitate to obtain a product of 3N-5N yttrium oxide.

10. The method according to claim 9, wherein the P507 mixed systems used in both separating the feed liquid of the medium-yttrium and europium-rich rare earth ore by the dysprosium-holmium grouping manner in Step 1 and separating the yttrium-rich material 1 by the erbium-thulium grouping manner in Step 3 are a P507-isooctanol mixed system, a P507-P227 mixed system or a P507-Cyanex272 mixed system.

11. The method according to claim 10, wherein process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-isooctanol mixed system are as follows: a P507 concentration of 1.0-1.5 mol/L, an isooctanol concentration of 10-30%, a saponification degree of 36%, and a hydrochloric acid concentration of 4.5-5.0 mol/L for stripping.

12. The method according to claim 10, wherein process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-Cyanex272 mixed system are as follows: a P507 concentration of 0.5-0.75 mol/L, a Cyanex272 concentration of 0.5-0.75 mol/L, a saponification degree of 36%, and a hydrochloric acid concentration of 2.5-3.5 mol/L for stripping.

13. The method according to claim 10, wherein process parameters for both separating the feed liquid of the medium-yttrium and europium-rich rare earth ore by the dysprosium-holmium grouping manner in Step 1 and separating the yttrium-rich material 1 by the erbium-thulium grouping manner in Step 3 with the P507-P227 mixed system are as follows: a P507 concentration of 0.5-0.75 mol/L, a P227 concentration of 0.5-0.75 mol/L, a saponification degree of 36%, and a hydrochloric acid concentration of 2.5-3.5 mol/L for stripping.

14. The method according to claim 9, wherein process parameters for separating the light and middle rare earth-enriched material into individual rare earths with the P507 system in Step 2 are as follows: a P507 concentration of 1.0-1.5 mol/L, a saponification degree of 36%, and a hydrochloric acid concentration of 3.5 mol/L for stripping.

15. The method according to claim 9, wherein in Step 4, yttrium oxide is directly extraction separated from the yttrium-rich material 2 with the mixed system of the carboxylic acid-based extractant HA-TPB, wherein the carboxylic acid-based extractant HA is sec-octyl phenoxyl substituted acetic acid or sec-nonyl phenoxyl substituted acetic acid.

16. The method according to claim 9, wherein process parameters for directly extraction separating yttrium oxide from the yttrium-rich material 2 with the mixed system of the carboxylic acid-based extractant HA-TBP in Step 4 are as follows: a carboxylic acid-based extractant HA concentration of 0.50-1.0 mol/L, a TBP concentration of 10-30%, a saponification degree of 80-90%, and a hydrochloric acid concentration of 2.0-3.0 mol/L for stripping.

17. The method according to claim 9, wherein the method is further suitable for separating yttrium oxide from a low-yttrium mixed rare earth ore obtained after extracting yttrium from a high-yttrium ore or a light rare earth ore by a grouping manner.
